(19) United States
(12) Patent Application Publication
(10) Pub. No.: US 2026/0145722 A1
(43) Pub. Date: May 28, 2026

(54) NOAHS ARK BABY STROLLER

(71) Applicant: Andrews Kwame Gyasi, Woodbridge, VA (US)

(72) Inventor: Andrews Kwame Gyasi, Woodbridge, VA (US)

(21) Appl. No.: 18/961,690

(22) Filed: Nov. 27, 2024

(51) Int. Cl. B62B 7/14; B62B 7/08; B62B 9/20; B62B 9/26; G09B 19/00

(52) U.S. Cl. CPC B62B 7/142; B62B 7/08; B62B 9/20; B62B 9/26; G09B 19/00; B62B 2205/06

(57) ABSTRACT

Noah's Ark Baby Stroller is an improved utility that includes a carriage portion, a movable seat portion, various adjustment mechanisms, and a learning tray attached to the seat portion that includes various tools adapted to teach children about religion, obedience to the word of God and salvation.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

### 1. Field of the Invention

This invention relates generally to baby strollers, and more specifically to an improved baby stroller, called Noah's Ark Baby Stroller, including adjustment mechanisms and a learning tray.

### 2. Description of the Related Art

Prior art baby strollers do include detachable seat portions, but are not fully adjustable, nor have any means of teaching the covenants of God nor about obedience to the word of God. Accordingly, the present invention overcomes the disadvantages associated with the prior art, by providing a baby stroller that includes a carriage portion, a movable seat portion, various adjustment mechanisms, and a learning tray attached to the seat portion that includes various tools adapted to teach children about religion and the word of God.

### BRIEF SUMMARY OF THE INVENTION

In view of the foregoing disadvantages inherent in the known types of baby stroller or the like in the prior art, the present invention provides a Noah's Ark Baby Stroller that includes a carriage portion, a movable seat portion, various adjustment mechanisms, and a learning tray attached to the seat portion that includes various tools adapted to teach children about religion, obedience to the word of God and salvation. Furthermore, it teaches them to be obedient and to follow God's direction and also the consequences of disobedience. By including an ark wheel and rainbow beads upon the learning tray it teaches them the biblical meaning of a rainbow, and it also implies a permanent covenant between God and man in that God will never destroy the earth again by flood. The Noah's Ark Baby Stroller will serve as a lesson to children that the days of Noah and Noah's ark show the second coming of Jesus and that any child who uses this stroller will be saved.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

### BRIEF DESCRIPTION OF THE DRAWINGS

The figures which accompany the written portion of this specification illustrate embodiments according to the teachings of the present invention.

FIG. 1 shows a perspective view of the Noah's Ark Baby Stroller according to the preferred embodiment of the present invention.

FIG. 2 shows a close-up perspective view of the Noah's Ark Baby Stroller according to the preferred embodiment of the present invention of FIG. 1.

FIG. 3 shows a perspective view of the learning tray of the Noah's Ark Baby Stroller according to the preferred embodiment of the present invention of FIG. 1.

FIG. 4 shows perspective bottom view of the Noah's Ark Baby Stroller according to the preferred embodiment of the present invention of FIG. 1.

FIG. 5 shows the rainbow colored beads used upon the learning tray of the Noah's Ark Baby Stroller according to the preferred embodiment of the present invention of FIG. 1.

The various embodiments of the present invention will hereinafter be described in conjunction with the appended drawings.

### DETAILED DESCRIPTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

The following embodiments and the accompanying drawings, which are incorporated into and form part of this disclosure, illustrate embodiments of the invention and together with the description, serve to explain the principles of the invention. To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

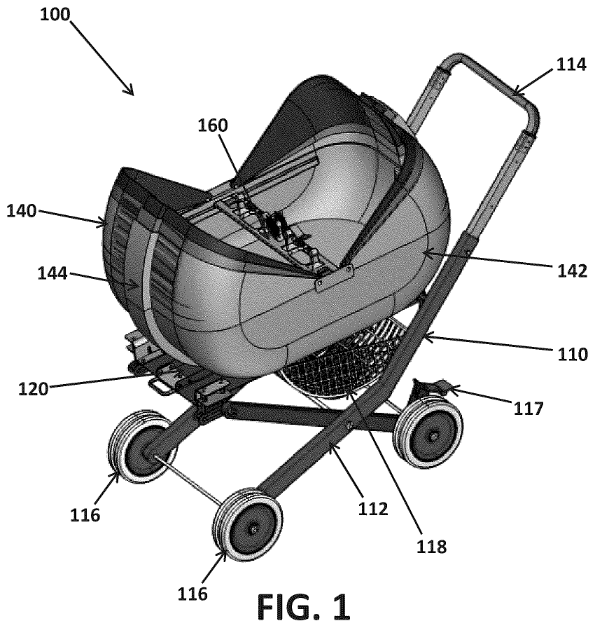

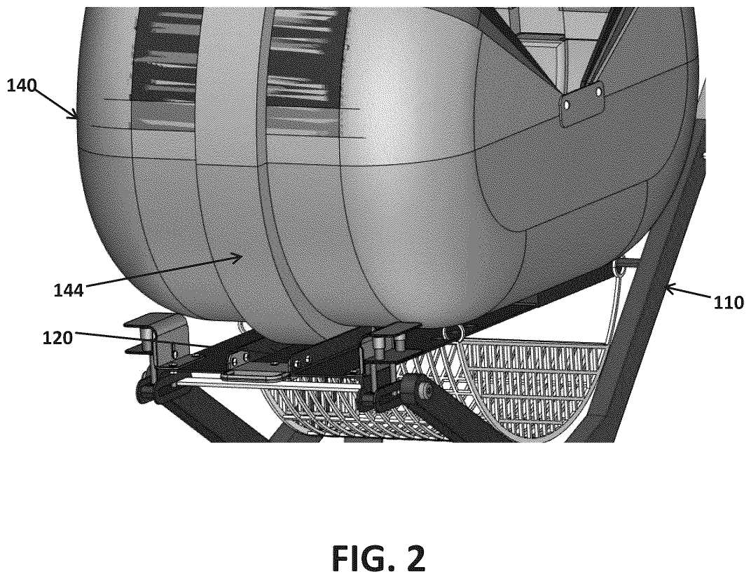

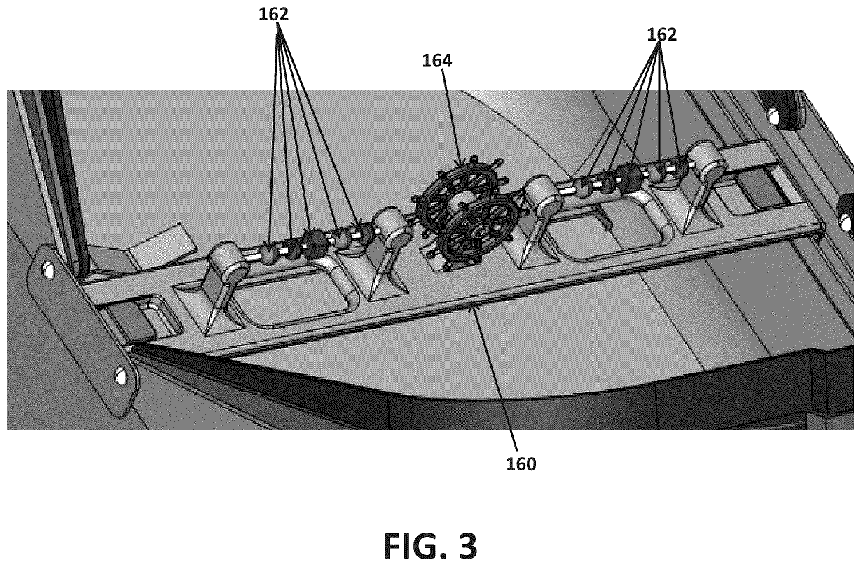

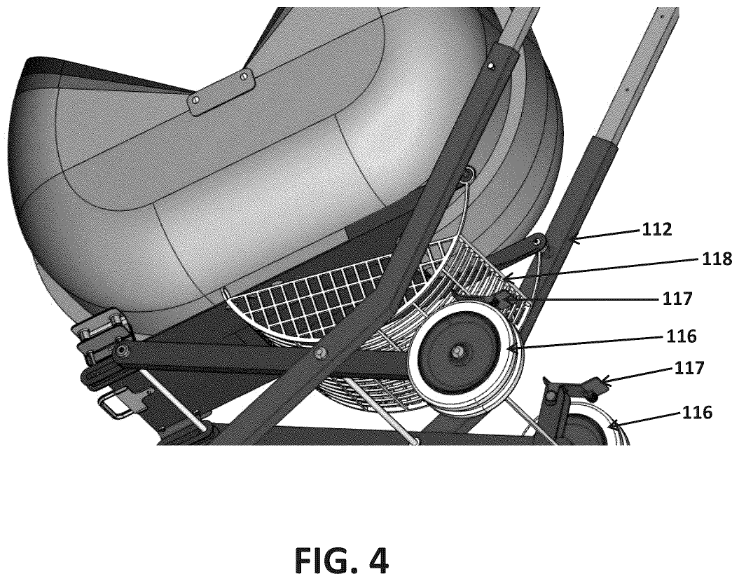

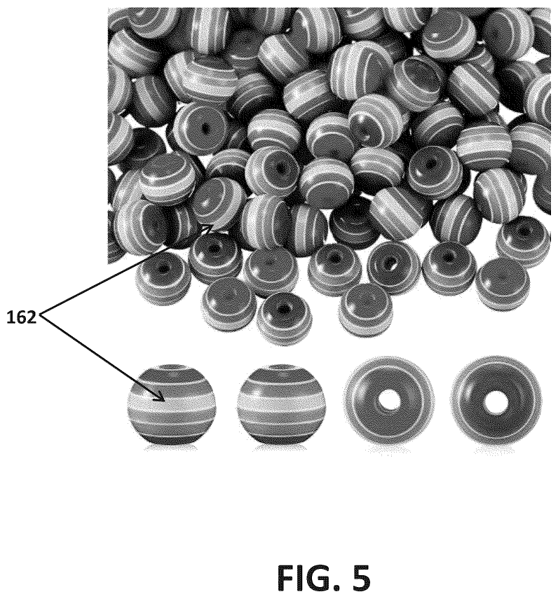

Turning now descriptively to drawing, referring to FIGS. 1-5, the present invention discloses a Noah's Ark Baby Stroller 100 comprising a carriage portion 110 including a frame 112, a handle 114 adjustably attached to the frame; a plurality of wheels 116 attached to the frame, a basket 118 attached to the frame, and an adjustment track 120 attached to the frame; a seat portion 140 including a main body 142 shaped and adapted to retain a baby therein, and an adjustment rail 144 located on a bottom portion of the main body and adapted to engage the adjustment track 120 of the carriage portion 110, such that the seat portion 140 is releasably held in place with respect to the carriage portion 110 in a chosen position; and a learning tray 160 including a plurality of beads 162, and an ark wheel 164, wherein the learning tray 160 is releasably attached to the seat portion 140 and adapted to be located above and in front of a baby placed within the seat portion 140.

In the preferred embodiment, the handle 114 telescopically engages the frame 112, such that the handle 114 is linearly adjustable. Furthermore, the front wheels of the plurality of wheels 116 are pivotably attached to the frame 110, and wherein there is at least one wheel braking mechanism 117, which can be formed as a pivoting friction panel pivotally attached to frame 110 that can frictionally engage a wheel 116 and lock it, and therefore the Noah's Ark Baby Stroller, in place. Furthermore, the frame 110 may be formed as a scissor-frame and foldable into a collapsed position.

In the preferred embodiment, the plurality of beads 162 are each formed having the colors of a rainbow thereon, including red, orange, yellow, green, blue, and violet; and wherein the colors of a rainbow are used to represent the biblical covenant with God promising to never flood and destroy the world again. Furthermore, the front wheels swivel for going around objects. Furthermore, the ark wheel 164 is used to represent the biblical ark of Noah and the biblical covenant with God promising to never flood and destroy the world again.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention.

What is claimed is:

1. The Noah's Ark Baby Stroller comprising:
a carriage portion including:
a frame;
a handle;
wherein said handle is adjustably attached to said frame;
a plurality of wheels;
wherein said plurality of wheels are attached to said frame;
a basket;
wherein said basket is attached to said frame; and
an adjustment track;
wherein said adjustment track is attached to said frame;
a seat portion including:
a main body;
wherein said main body is shaped and adapted to retain a baby therein and
an adjustment rail;
wherein said adjustment rail is located on a bottom portion of said main body and adapted to engage said adjustment track of said carriage portion, such that said seat portion is releasably held in place with respect to said carriage portion in a chosen position;
a learning tray including:
a plurality of beads; and
an ark wheel;
wherein said learning tray is releasably attached to said seat portion and adapted to be located above and in front of a baby placed within said seat portion.

2. The Noah's Ark Baby Stroller of claim 1, wherein said handle telescopically engages said frame, such that said handle is linearly adjustable.

3. The Noah's Ark Baby Stroller of claim 1, wherein each of said plurality of wheels are pivotably attached to said frame; and wherein at least one of said plurality of wheels is adapted to be locked in place via a braking mechanism.

4. The Noah's Ark Baby Stroller of claim 3, wherein each of said at least one braking mechanism includes a pivoting friction panel pivotally attached to said frame and adapted to frictionally engage a respective said wheel to lock it, and therefore said improved baby stroller, in place.

5. The Noah's Ark Baby Stroller of claim 1, wherein said frame is formed as a scissor-frame and foldable into a collapsed position.

6. The Noah's Ark Baby Stroller of claim 1, wherein said plurality of beads are each formed having the colors of a rainbow thereon; wherein said colors of a rainbow are used to represent the rainbow God used as an everlasting covenant between God and man to never destroy the world by flood again.
